(19) United States
(12) Patent Application Publication
(10) Pub. No.: US 2011/0260779 A1
(43) Pub. Date: Oct. 27, 2011

(54) CURRENT BALANCING DEVICE FOR PARALLEL BATTERIES AND CONTROL METHOD THEREOF

(75) Inventor: Shuan-Ta LIU, Taipei City (TW)

(73) Assignee: Neoton Optoelectronics Corp., Taipei City (TW)

(21) Appl. No.: 13/092,861

(22) Filed: Apr. 22, 2011

(30) Foreign Application Priority Data
Apr. 23, 2010 (TW) 099112932
Mar. 15, 2011 (TW) 100108777

(51) Int. Cl. G05F 1/10

(52) U.S. Cl. 327/520

(57) ABSTRACT

A current balancing device for parallel batteries is electrically connected with a load. The current balancing device includes a buck module, a normal module, a current comparing module and a control module. The buck module is electrically connected with a high voltage battery and outputs a first current to the load. The normal module is electrically connected with a low voltage battery and outputs a second current to the load. The current comparing module is electrically connected with the buck module and the normal module, and compares the first current with the second current to output a first comparing signal. The control module is electrically connected with the buck module and the current comparing module, and outputs a control signal to the buck module in accordance with the first comparing signal for adjusting the first current.

### CROSS REFERENCE TO RELATED APPLICATIONS

This Non-provisional application claims priority under 35 U.S.C. §119(a) on Patent Application No(s). 099112932 filed in Taiwan, Republic of China on Apr. 23, 2010, and No(s). 100108777 filed in Taiwan, Republic of China on Mar. 15, 2011, the entire contents of which are hereby incorporated by reference.

### BACKGROUND OF THE INVENTION

1. Field of Invention

The present invention relates to a current balancing device for batteries and a control method thereof. In particularly, the present invention relates to a current balancing device for parallel batteries and a control method thereof

2. Related Art

The conventional vehicles or generators that use petroleum fuels such as gasoline or diesel oil usually release many pollutants to the air. This has become a very serious issue recently, so that the scientists devote to develop the replacement of the power source of vehicles or generators, such as batteries. Since large voltage and current are needed to drive and operate the vehicles or other large machines, it is necessary to connect multiple batteries in parallel or in series for providing sufficient output voltage and/or current for driving the vehicles or other large machines.

As shown in FIG. 1, a conventional power supply unit 1 (parallel batteries) includes a first battery 11 and a second battery 12, which provide a current to the load L respectively. Although the circuit structure of the conventional power supply unit 1 is simpler, it may have a problem that the currents outputted from the batteries are usually changed due to the variations of the residual powers and internal resistances of the batteries. In such a case, the output current of one of the batteries may be too large, which usually speeds the ageing and damage of the battery.

If the power supply unit is composed of a plurality of batteries connected in series, the property variations between the batteries become more obvious while the number of the batteries connected in series increases. Besides, the currents provided by the batteries to the load become non-uniform. In addition, if the batteries of the power supply unit are the rechargeable secondary batteries, the property variations between the parallel batteries may cause additional power loss. For example, in the parallel batteries, the battery with higher voltage may charge the other battery with lower voltage. This undesired charging between the parallel batteries usually causes the extra power loss.

Therefore, it is an important subject of the invention to provide a current balancing device for parallel batteries and a control method thereof that can balance the output currents of the parallel batteries based on the property variations between the batteries, thereby extending the lifetime of the batteries.

### SUMMARY OF THE INVENTION

In view of the foregoing, an objective of the invention is to provide a current balancing device for parallel batteries and a control method thereof that can balance the output currents of the parallel batteries based on the property variations between the batteries.

To achieve the above objective, the present invention discloses a current balancing device for parallel batteries. The current balancing device is electrically connected with a load and includes a buck module, a normal module, a current comparing module and a control module. The buck module is electrically connected with a high voltage battery and outputs a first current to the load. The normal module is electrically connected with a low voltage battery and outputs a second current to the load. The current comparing module is electrically connected with the buck module and the normal module, and compares the first current with the second current to output a first comparing signal. The control module is electrically connected with the buck module and the current comparing module, and outputs a control signal to the buck module in accordance with the first comparing signal for adjusting the first current.

In one embodiment of the invention, each of the high voltage battery and the low voltage battery is a secondary battery.

In one embodiment of the invention, the high voltage battery and the low voltage battery are connected in parallel.

In one embodiment of the invention, the control signal controls the buck module to increase the first current to a target value.

To achieve the above objective, the present invention also discloses a control method of a current balancing device for balancing the output currents of at least two batteries. The control method includes the following steps of: determining which one of the batteries has higher output voltage; electrically connecting the battery having the higher output voltage to a buck module; electrically connecting the battery having the lower output voltage to a normal module; outputting a first current and a second current respectively from the buck module and the normal module to a load; and comparing the first current and the second current so as to adjust the first current.

In one embodiment of the invention, the batteries are secondary batteries.

In one embodiment of the invention, the control method further includes the steps of: detecting the first current and the second current so as to output a first detecting signal and a second detecting signal respectively; comparing the first detecting signal and the second detecting signal so as to output a first comparing signal; and outputting a control signal to adjust the first current according to the first comparing signal and a second comparing signal.

As mentioned above, the current balancing device of the present invention includes a buck circuit electrically connected with the high voltage battery. Besides, the current balancing device of the present invention further includes a current comparing module and a control module for generating a control signal to the buck circuit, thereby adjusting the first current outputted from the high voltage battery. Accordingly, the present invention can balance the output currents of the batteries based on the property variations of the batteries, so that the lifetime of the batteries can be extended.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram showing a conventional power supply unit with parallel batteries;

FIG. 2 is a schematic diagram showing a current balancing device for parallel batteries according to a preferred embodiment of the present invention;

FIG. 3 is a detailed schematic diagram of the current balancing device of FIG. 3;

FIG. 4A and FIG. 4B are flow charts of a control method of the current balancing device according to a preferred embodiment of the present invention; and

FIG. 5 is a schematic graph showing the first current and the second current according to the preferred embodiment of the present invention.

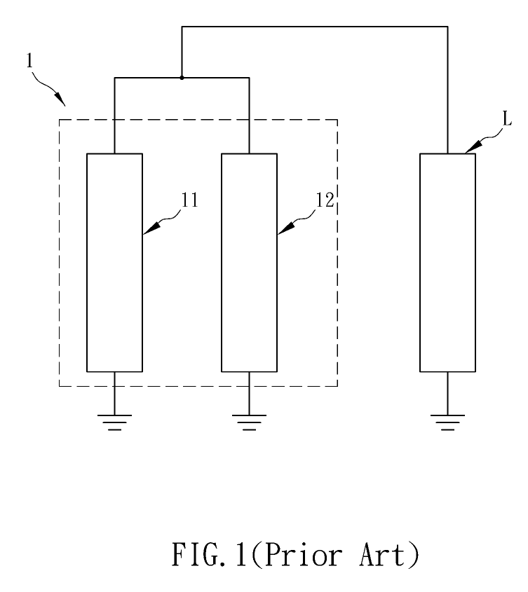

### DETAILED DESCRIPTION OF THE INVENTION

The present invention will be apparent from the following detailed description, which proceeds with reference to the accompanying drawings, wherein the same references relate to the same elements.

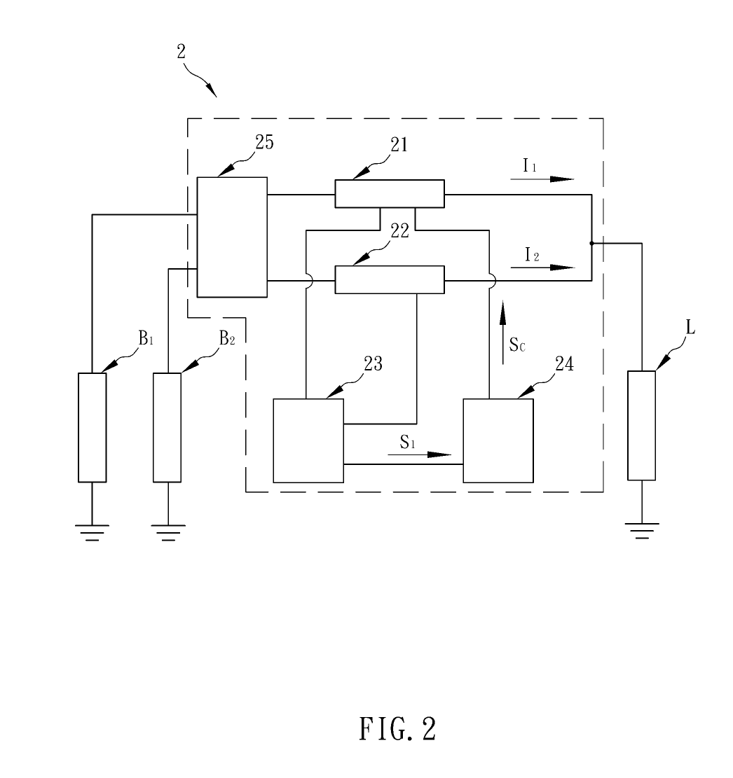

FIG. 2 is a schematic diagram showing a current balancing device 2 for parallel batteries according to a preferred embodiment of the present invention. Referring to FIG. 2, the current balancing device 2 is electrically connected with a load L, so that it can receives electric powers from a high voltage battery and a low voltage battery and then output a current to the load L.

In practice, the high voltage battery and the low voltage battery are connected in parallel. Each of the high voltage battery and the low voltage battery can be a primary battery, a secondary battery or a solar cell. In addition, the high voltage battery and the low voltage battery may be made of the same material or have the same spec, but they may have different voltage values due to their property variations.

The current balancing device 2 includes a buck module 21, a normal module 22, a current comparing module 23, a control module 24, and an input switch module 25. The buck module 21 is electrically connected with the high voltage battery and outputs a first current I₁ to the load L. The normal module 22 is electrically connected with the low voltage battery and outputs a second current I₂ to the load L.

The current comparing module 23 is electrically connected with the buck module 21 and the normal module 22 for comparing the first current I₁ with the second current I₂ to output a first comparing signal S₁.

The control module 24 is electrically connected with the buck module 21 and the current comparing module 23, and outputs a control signal S_{C} to the buck module 21 in accordance with the first comparing signal S₁ for adjusting the first current I₁ outputted by the buck module 21.

To be noted, the buck module 21 and the normal module 22 of the current balancing device 2 of this embodiment are, for example, electrically connected with the high voltage battery and the low voltage battery respectively. In practice, it is also possible to provide a plurality of buck modules or normal modules for cooperating with batteries of other numbers.

The input switch module 25 is connected with a first battery B₁ and a second battery B₂ for selecting the high voltage battery from one of the first battery B₁ and the second battery B₂ that has higher output voltage and selecting the low voltage battery from the other one of the first battery B₁ and the second battery B₂ that has lower output voltage. Then, the input switch module 25 can control to electrically connect the selected high voltage battery to the buck module 21, and to electrically connect the selected low voltage battery to the normal module 22.

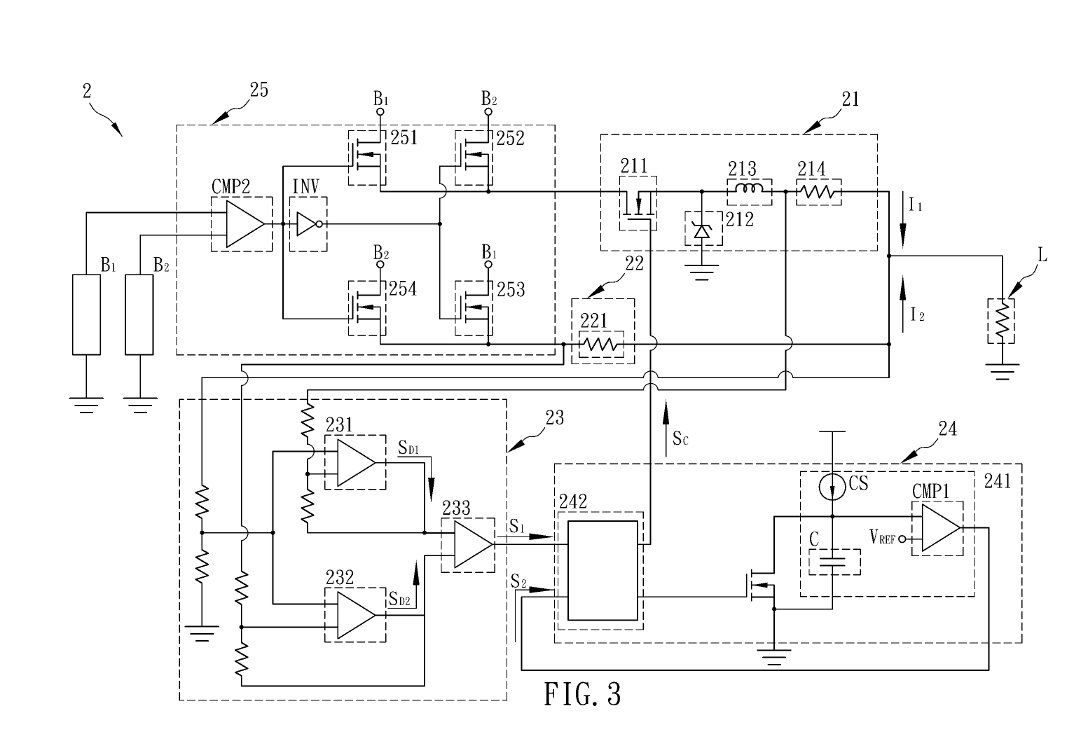

The current balancing device 2 of the present invention will be further described in details with reference to FIG. 3. The buck module 21 of the current balancing device 2 includes a switch element 211, a diode 212, an inductor 213, and a first detecting element 214. The switch element 211 is electrically connected with the high voltage battery and turned on/off according to the control signal S_{C} outputted by the control module 24. The cathode of the diode 212 is electrically connected with the switch element 211, and anode thereof is grounded. The inductor 213 is electrically connected with the switch element 211 and the cathode of the diode 212 for outputting the first current I₁. The two ends of the first detecting element 214 are electrically connected with the inductor 213 and the load L, respectively, for outputting the first current I₁ to the load L.

In operation, when the switch element 211 is turned on, the first current I₁ can flow through the switch element 211, the inductor 213 and the first detecting element 214, and then be outputted to the load L. Accordingly, the current value of the first current I₁ is continuously increased until reaching a target value. When the switch element 211 is turned off, the first current I₁ can flow through the diode 212, the inductor 213 and the first detecting element 214, and then be outputted to the load L. Accordingly, the current value of the first current I₁ is continuously decreased.

The normal module 22 includes a second detecting element 221. One end of the second detecting element 221 is electrically connected with the low voltage battery, and the other end thereof is electrically connected with the first detecting element 214 and the load L for outputting the second current I₂ to the load L.

In practice, the switch element 211 can be a bipolar junction transistor (BJT), a field-effect transistor (FET), or an insulated gate bipolar transistor (IGBT). The diode 212 can be a Schottky diode. The first detecting element 214 and the second detecting element 221 can be resistors with the same resistance value.

The current comparing module 23 includes a first comparing unit 231, a second comparing unit 232, and a current comparing unit 233. The two input ends of the first comparing unit 231 are electrically connected with two ends of the first detecting element 214 for outputting a first detecting signal S_{D1}. The two input ends of the second comparing unit 232 are electrically connected with two ends of the second detecting element 221 for outputting a second detecting signal S_{D2}. The current comparing unit 233 is electrically connected with the output ends of the first comparing unit 231 and the second comparing unit 232, and outputs the first comparing signal S₁ according to the first detecting signal S_{D1} and the second detecting signal S_{D2}.

In practice, the current balancing device 2 utilizes the first comparing unit 231 and the second comparing unit 232 to measure the potential differences generated by the first detecting element 214 and the second detecting element 221. Then, the current comparing unit 233 can calculate to determine whether the current values of the first current I₁ and the second current I₂ are equal to each other.

In the present embodiment, each of the junction points of the two input ends of the first comparing unit 231 and the first detecting element 214 is configured with a voltage division circuit, and each of the junction points of the two input ends of the second comparing unit 232 and the second detecting element 221 is also configured with a voltage division circuit. In this case, the resistance values of the voltage division circuits can be different according to the actual demands. For example, it is possible to use resisters with the same resistance value to form the voltage division circuits. Alternatively, the resistors of the voltage division circuits can be variable resistors or digital potentiometers, so that the designer or user can made desired adjustment to the voltage division circuits.

The control module 24 includes a timing unit 241 and a flip-flop 242. In this embodiment, the timing unit 241 includes a capacitor C, a comparator CMP1, and a constant-current source CS. The capacitor C is electrically connected with the constant-current source CS, so that the capacitor C can be charged by the constant-current source CS. The two input ends of the comparator CMP1 are electrically connected with the capacitor C and a reference power source V_{REF}, respectively. When the capacitor C is charged by the constant-current source CS and reaches the reference power source V_{REF}, the comparator CMP1 outputs a second comparing signal S₂. The flip-flop 242 is electrically connected with the comparator CMP1 of the timing unit 241 and the current comparing unit 233 of the current comparing circuit 23. Accordingly, the flip-flop 242 can output the control signal S_{C} according to the first comparing signal S₁ and the second comparing signal S₂.

In practice, the timing unit 241 periodically outputs the second comparing signal S₂ for notifying the flip-flop 242 to turn on the switch element 211 of the buck module 21.

In this embodiment, the timing unit 241 may include a transistor switch, which is electrically connected with the capacitor C, for providing a discharge path to the capacitor C. In addition, the transistor switch is electrically connected with the flip-flop 242 and is switched according to the second comparing signal S₂. In practice, the flip-flop 242 is a RS flip-flop. The reset end and the set end thereof receive the first comparing signal S₁ and the second comparing signal S₂ respectively. The output end and the inverting input end thereof are electrically connected with the switch element 211 of the buck module and the transistor switch of the timing unit 241 respectively.

The input switch module 25 includes a comparator CMP2, an inverter INV, a first switch unit 251, a second switch unit 252, a third switch unit 253, and a fourth switch unit 254.

The two input ends of the comparator CMP2 are electrically connected with the first battery B₁ and the second battery B₂, respectively, for comparing the voltage values of the first battery B₁ and the second battery B₂. The inverter INV has an input end and an output end. The input end of the inverter INV is electrically connected with the output end of the comparator CMP2.

The first switch unit 251 is electrically connected with the input end of the inverter INV and the output end of the comparator CMP2, and it can be controlled to switch according to the signal outputted by the comparator CMP2. The second switch unit 252 is electrically connected with the output end of the inverter INV, and it can be controlled to switch according to the signal outputted by the inverter INV. The third switch unit 253 is electrically connected with the input end of the inverter and the output end of the comparator CMP2, and it can be controlled to switch according to the signal outputted by the comparator CMP2. The fourth switch unit 254 is electrically connected with the output end of the inverter INV, and it can be controlled to switch according to the signal outputted by the inverter INV.

When the output voltage of the first battery B₁ is larger than that of the second battery B₂, the comparator CMP2 outputs a high-level signal for turning on the first switch unit 251 and the third switch 253. This operation can determine that the first battery B₁ is the high voltage battery and is electrically connected with the buck module 21, and determine that the second battery B₂ is the low voltage battery and is electrically connected with the normal module 22. At the same time, the inverter INV outputs a low-level signal for turning off the second switch unit 252 and the fourth switch 254.

Alternatively, when the output voltage of the second battery B₂ is larger than that of the first battery B₁, the comparator CMP2 outputs a low-level signal for turning off the first switch unit 251 and the third switch 253. At the same time, the inverter INV outputs a high-level signal for turning on the second switch unit 252 and the fourth switch 254. This operation can determine that the second battery B₂ is the high voltage battery and is electrically connected with the buck module 21, and determine that the first battery B₁ is the low voltage battery and is electrically connected with the normal module 22.

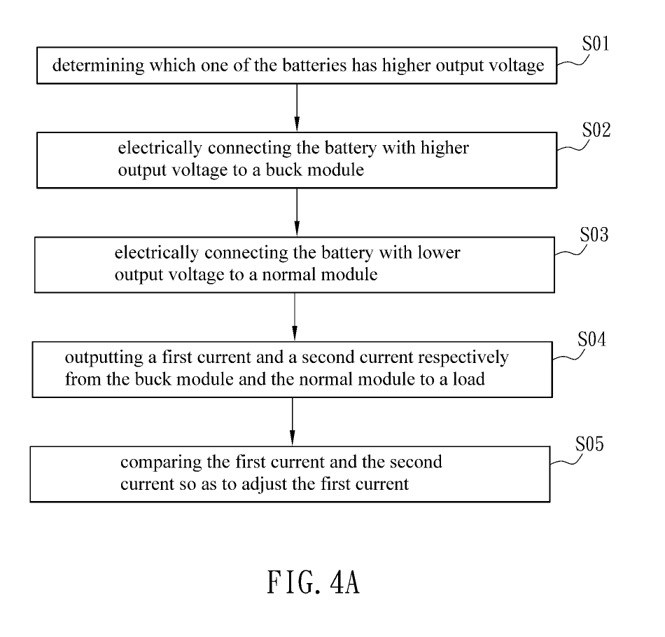

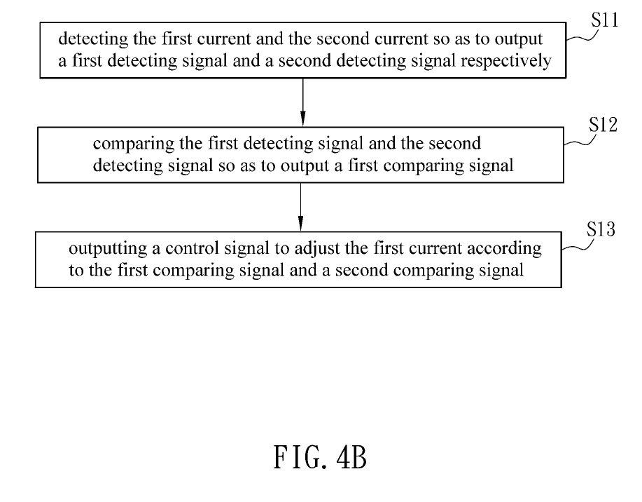

The control method of the current balancing device 2 (as mentioned above) according to the preferred embodiment of the invention will be described hereinbelow with reference to FIG. 4A in view of FIG. 3. The control method of the current balancing device 2 includes the following steps S01 to S05.

The step S01 is to determine which one of the first battery B₁ and the second battery B₂ has higher output voltage. In this embodiment, this step S01 is performed by using the comparator CMP2 of the input switch module 25 to receive and compare the output voltages of the first battery B₁ and the second battery B₂.

The step S02 is to electrically connect the battery with higher output voltage to a buck module 21. In this embodiment, the output voltage of the first battery B₁ is higher than that of the second battery B₂ for example. In this case, the comparator CMP2 outputs a high-level signal to turn on the first switch unit 251, so that the first battery B₁ is determined as the high voltage battery and is electrically connected with the buck module 21. Besides, the high-level signal outputted by the comparator CMP2 is inverted by the inverter INV to generate a low-level signal, which can turn off the second switch unit 252.

The step S03 is to electrically connect the battery with lower output voltage to a normal module 22. In this embodiment, since the output voltage of the first battery B₁ is higher than that of the second battery B₂, the comparator CMP2 outputs a high-level signal to turn on the third switch unit 253, so that the second battery B₂ is determined as the low voltage battery and is electrically connected with the normal module 22. At the same time, the fourth switch unit 254 is turned off.

The step S04 is to output a first current I₁ and a second current I₂ respectively from the buck module 21 and the normal module 22 to a load L. In practice, when the high voltage battery and the low voltage battery are electrically connected with the buck circuit 21 and the normal circuit 22 respectively, they can output a first current I₁ and a second current I₂ respectively to a load L.

The step S05 is to compare the first current I₁ and the second current I₂ so as to adjust the first current I₁. In this embodiment, the step SO5 is performed by the current comparing module 23 to compare the first current I₁ and the second current I₂. Then, the control module 24 outputs a control signal S_{C} to switch the switch element 211 of the buck circuit 21, thereby adjusting the current value of the first current I₁.

In order to make this embodiment more comprehensive, the details of the step S05 will be described with reference to FIG. 4B in view of FIG. 3. As shown in FIG. 4B, the step S05 includes steps S11 to S13. The step S11 is to detect the first current I₁ and the second current I₂ so as to output a first detecting signal S_{D1} and a second detecting signal S_{D2} respectively. In practice, the first comparing unit 231 and the second comparing unit 232 of the current comparing module 23 can measure the potential differences generated by the first detecting element 214 of the buck module 21 and the second detecting element 221 of the normal module 22, and then output the first detecting signal S_{D1} and the second detecting signal S_{D2} to the current comparing unit 233 respectively.

The step S12 is to compare the first detecting signal S_{D1} and the second detecting signal S_{D2} so as to output a first comparing signal S₁. In this embodiment, the current comparing unit 233 receives and compares the first detecting signal S_{D1} and the second detecting signal S_{D2}. When the first current I₁ is smaller than the second current I₂, the second detecting signal S_{D2} is smaller than the first detecting signal S_{D1}, so that the current comparing unit 233 outputs a low-level first comparing signal S₁. Alternatively, when the first current I₁ is equal to the second current I₂, the first detecting signal S_{D1} is larger than the second detecting signal S_{D2}, so that the current comparing unit 233 outputs a high-level first comparing signal S₁.

The step S13 is to output a control signal S_{C} to adjust the first current I₁ according to the first comparing signal S₁ and a second comparing signal S₂. In this embodiment, the constant-current source CS of the timing unit 241 can charge the capacitor C. When the potential of the capacitor C reaches a reference power source V_{REF}, the comparator CMP1 outputs a high-level second comparing signal S₂ to the flip-flop 242, so that the switch element 211 of the buck module 21 is turned on. Accordingly, the first current I₁ can flow through the switch element 211, the inductor 213, and the first detecting element 214, and then be outputted to the load L. Besides, the current value of the first current I₁ is continuously increased to a target value. For example, the current value of the first current I₁ can be continuously increased to reach the current value of the second current I₂.

When the current value of the first current I₁ is continuously increased to the target value, the flip-flop 242 of the control module 24 can turn off the switch element 211 of the buck module 21 according to the first comparing signal S₁ outputted by the current comparing module 23. In this case, the first current can flow through the diode 212, the inductor 213, and the first detecting element 214, and then be outputted to the load L. Then, after a preset time period, the constant-current source CS can charge the potential of the capacitor C to the reference power source V_{REF}, so that the switch element 211 can be turned on again. The preset time period is C*V/I, wherein C is the capacitance value of the capacitor C, V is the potential of the reference power source V_{REF}, and I is the current value of the constant-current source CS.

To be noted, the current balancing device may further include a microprocessor for cooperating with the digital potentiometer of the voltage division circuit. For example, the designer or user may set a group or multiple groups of trigger values and adjustment values in the microprocessor, so that the microprocessor can adjust the digital potentiometer according to the preset trigger values and adjustment values, thereby modifying the current value of the first current to reach the desired value. In other words, the current balancing device can automatically adjust the target value according to the residual powers of the first and second batteries so as to achieve the desired current balance. Of course, the designer and user may also manually adjust the target value.

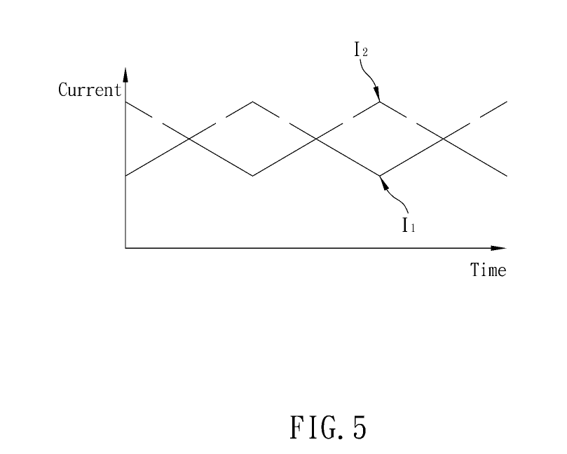

FIG. 5 is a schematic graph showing the first current I₁ and the second current I₂ outputted by the buck module 21 and the normal module 22 respectively.

In this embodiment, when the switch element 211 is turned on, the first current I₁ is continuously increased; otherwise, when the switch element 211 is turned off, the first current I₁ is continuously decreased. In addition, the second current I₂ can be changed based on the variation of the first current I₁, thereby providing the necessary operation current to the load L.

Based on the above-mentioned hardware structure and control method, the switch element 211 can be periodically turned on/off through the current comparing module 23 and the control module 24. Thus, the first current I₁ outputted by the buck module 21 can be changed within an operation range. This can prevent the event that the battery with high voltage may continuously supply the larger current, which usually speeds the ageing and damage of the battery.

In the above embodiments, the current balancing device of parallel batteries and the control method thereof are especially suitable for the secondary batteries with high power output, such as the batteries for the electric vehicles, hybrid vehicles, generators, and the likes.

To be noted, if the first battery B₁ and the second battery B₂ are both solar cells, the misfit issue of the solar cells may also occur while the solar cells are blocked by the shadows of trees, smokestacks, or other higher buildings. In other words, the output powers of the parallel solar cells may lose balance due to the block of other objects, and this may make the solar cell be overheated and damaged. Accordingly, for the case that the first battery B₁ and the second battery B₂ are both solar cells, the current balancing device 2 can not only effectively balance the output currents of the first battery B₁ and the second battery B₂, but also can decrease the reverse current. Moreover, the first battery B₁ and the second battery B₂ can be protected from being damaged by the hot spots.

As mentioned above, the current balancing device of the present invention includes a buck circuit electrically connected with the high voltage battery. Besides, the current balancing device of the present invention further includes a current comparing module and a control module for generating a control signal to the buck circuit, thereby adjusting the first current outputted from the high voltage battery. Accordingly, the present invention can balance the output currents of the batteries based on the property variations of the batteries, so that the lifetime of the batteries can be extended.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A current balancing device for parallel batteries, which is electrically connected with a load, comprising:
a buck module electrically connected with a high voltage battery and outputting a first current to the load;
a normal module electrically connected with a low voltage battery and outputting a second current to the load;
a current comparing module electrically connected with the buck module and the normal module for comparing the first current with the second current to output a first comparing signal; and
a control module electrically connected with the buck module and the current comparing module for outputting a control signal to the buck module in accordance with the first comparing signal for adjusting the first current.

2. The current balancing device according to claim 1, wherein the buck module comprises:
a switch element electrically connected with the high voltage battery and turned on/off according to the control signal;
a diode electrically connected with the switch element; and
an inductor electrically connected with the switch element and the diode for outputting the first current.

3. The current balancing device according to claim 1, wherein the high voltage battery and the low voltage battery are secondary batteries.

4. The current balancing device according to claim 1, wherein the buck module comprises a first detecting element, the normal module comprises a second detecting element, the first current and the second current are outputted to the load respectively through the first detecting element and the second detecting element, and the current comparing module comprises:
a first comparing unit electrically connected with two ends of the first detecting element for outputting a first detecting signal;
a second comparing unit electrically connected with two ends of the second detecting element for outputting a second detecting signal; and
a current comparing unit electrically connected with the first comparing unit and the second comparing unit and outputting the first comparing signal to the control circuit according to the first detecting signal and the second detecting signal.

5. The current balancing device according to claim 1, wherein the control signal controls the buck module to increase the first current to a target value.

6. The current balancing device according to claim 1, wherein the control module comprises:
a timing unit comprising a capacitor, a comparator, and a constant-current source, wherein the capacitor is electrically connected with the constant-current source, and the comparator is electrically connected with the capacitor and a reference power source and outputs a second comparing signal; and
a flip-flop electrically connected with the timing unit and the current comparing circuit and outputting the control signal according to the first comparing signal and the second comparing signal.

7. The current balancing device according to claim 1, further comprising:
an input switch module for selecting the high voltage battery from one of a first battery and a second battery that has higher output voltage, and selecting the low voltage battery from the other one of the first battery and the second battery that has lower output voltage.

8. The current balancing device according to claim 7, wherein the input switch module comprises:
a comparator having two input ends electrically connected with the first battery and the second battery respectively;
an inverter having an input end electrically connected with an output end of the comparator;
a first switch unit electrically connected with the input end of the inverter for controlling whether the first battery is the high voltage battery for electrically connecting with the buck module;
a second switch unit electrically connected with an output end of the inverter for controlling whether the second battery is the high voltage battery for electrically connecting with the buck module;
a third switch unit electrically connected with the input end of the inverter for controlling whether the first battery is the low voltage battery for electrically connecting with the normal module; and
a fourth switch unit electrically connected with the output end of the inverter for controlling whether the second battery is the low voltage battery for electrically connecting with the normal module.

9. A control method of a current balancing device applied to balance output currents of at least two batteries, comprising steps of:
determining which one of the batteries has higher output voltage;
electrically connecting the battery having the higher output voltage to a buck module;
electrically connecting the battery having the lower output voltage to a normal module;
outputting a first current and a second current respectively from the buck module and the normal module to a load; and
comparing the first current and the second current so as to adjust the first current.

10. The control method according to claim 9, wherein the step of comparing the first current and the second current comprises:
detecting the first current and the second current so as to output a first detecting signal and a second detecting signal respectively;
comparing the first detecting signal and the second detecting signal so as to output a first comparing signal; and
outputting a control signal to adjust the first current according to the first comparing signal and a second comparing signal.
